(19) United States
(12) Patent Application Publication
(10) Pub. No.: US 2012/0191762 A1
(43) Pub. Date: Jul. 26, 2012

(54) PROVIDING ASSISTED BUSINESS ANALYSIS TO USERS

(75) Inventors: Michael Adendorff, Surrey (CA); Valentin Balteanu, Ottawa (CA); Ilse M. Breedvelt-Schouten, Manotick (CA); Gregory J. Fitzpatrick, St. Albans (GB); Carm Janneteau, Manotick (CA)

(73) Assignee: INTERNATIONAL BUSINESS MACHINES CORPORATION, Armonk, NY (US)

(21) Appl. No.: 13/430,123

(22) Filed: Mar. 26, 2012

Related U.S. Application Data
(63) Continuation of application No. 12/957,806, filed on Dec. 1, 2010.

(51) Int. Cl. G06F 7/00

(52) U.S. Cl. 707/803; 707/E17.044

(57) ABSTRACT

A method for providing assisted business analysis to users is disclosed herein. In one embodiment, such a method includes providing a list of one or more predefined managed reports to a user. Each predefined managed report has specific metadata associated therewith. The method further provides functionality to enable the user to select a specific managed report from the list. Once a managed report is selected from the list, the method enables the user to generate a new ad hoc report from the selected managed report. Generating this new ad hoc report includes automatically extracting all or part of the metadata from the selected managed report to build the new ad hoc report. A corresponding computer program product and apparatus are also disclosed herein.

### BACKGROUND

1. Field of the Invention

This invention relates to apparatus and methods for providing assisted business analysis to users.

2. Background of the Invention

Analysis of business data is a task that typically requires specialist skills Business Intelligence (BI) technologies have allowed consumers of information to have access to more information, but that information is typically not delivered in a way that permits self-service business analysis for consumers. Current solutions typically focus on delivering static, predefined reporting content (often referred to as “managed reporting”), which is effective to help consumers understand the current state of a business, but is often too restrictive in coverage to enable consumers to develop any meaningful business insight through analysis.

Other alternative technologies (generally referred to as on-line analytic processing, or OLAP) allow for more open-ended exploration of business data, but are best suited for skilled business analysts who are capable of building complex multi-step operations to carry out simple business analysis tasks. Other current technologies provide consumers with broad sets of analytic tools to perform open-ended self service analysis, but these technologies are typically restricted to operate in predefined business domain areas. The most widespread implementation of these special-function analysis tools is in the area of stock portfolio performance and analysis. The ad hoc analyses provided by these systems are tailored to the analysis of stock prices and cannot be applied to general business data.

In view of the foregoing, what are needed are apparatus and methods to enable users to perform meaningful analysis on business data from different business domains. In particular, it would be an advance in the art to enable users to use existing managed reports to perform ad hoc analyses without the help of skilled business analysts.

### SUMMARY

The invention has been developed in response to the present state of the art and, in particular, in response to the problems and needs in the art that have not yet been fully solved by currently available apparatus and methods. Accordingly, the invention has been developed to provide assisted business analysis to users. The features and advantages of the invention will become more fully apparent from the following description and appended claims, or may be learned by practice of the invention as set forth hereinafter.

Consistent with the foregoing, a method for providing assisted business analysis to users is disclosed herein. In one embodiment, such a method includes providing a list of one or more predefined managed reports to a user. Each predefined managed report has specific metadata associated therewith. The method further provides functionality to enable the user to select a specific managed report from the list. Once a managed report is selected from the list, the method enables the user to generate a new ad hoc report from the selected managed report. Generating this new ad hoc report includes automatically extracting all or part of the metadata from the selected managed report to build the new ad hoc report.

A corresponding computer program product and apparatus are also disclosed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computer system suitable for use with embodiments of the invention;

FIG. 2 shows one embodiment of an apparatus for providing assisted business analysis to a user;

FIG. 3 shows one exemplary presentation of a managed report;

FIG. 4 shows one example of a user interface for selecting analysis data for a managed report;

FIG. 5 shows a modified managed report using the analysis data selected in FIG. 4;

FIG. 6 shows one example of a user interface for selecting different analytic styles used to generate new ad hoc reports; and

FIG. 7 shows one example of a new ad hoc report generated upon selecting the “period-on-period” analytic style.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “apparatus.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to various embodiments of the invention. It will be understood that each block of the flowchart illustrations and/or block diagrams, and combinations of blocks in the flowchart illustrations and/or block diagrams, may be implemented by computer program instructions or code. The computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

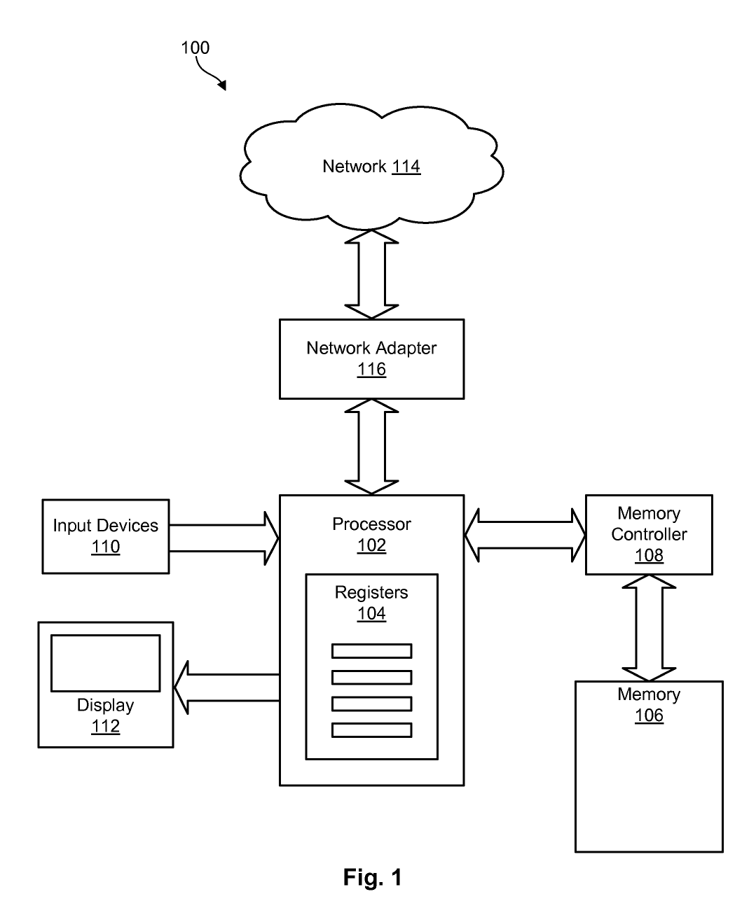

Referring to FIG. 1, one example of a computer system 100 is illustrated. The computer system 100 is presented to show one example of an environment where an apparatus and method in accordance with the invention may be implemented. The computer system 100 is presented only by way of example and is not intended to be limiting. Indeed, the apparatus and methods disclosed herein may be applicable to a wide variety of different computer systems in addition to the computer system 100 shown. The apparatus and methods disclosed herein may also potentially be distributed across multiple computer systems 100.

The computer system 100 includes at least one processor 102 and may include more than one processor. The processor 102 includes one or more registers 104 storing data describing the state of the processor 102 and facilitating execution of software systems. The registers 104 may be internal to the processor 102 or may be stored in a memory 106. The memory 106 stores operational and executable data that is operated upon by the processor 102. The memory 106 may be accessed by the processor 102 by means of a memory controller 108. The memory 106 may include volatile memory (e.g., RAM) as well as non-volatile memory (e.g., ROM, EPROM, EEPROM, hard disks, flash memory, etc.).

The processor 102 may be coupled to additional devices supporting execution of software and interaction with users. For example, the processor 102 may be coupled to one or more input devices 110, such as a mouse, keyboard, touch screen, microphone, or the like. The processor 102 may also be coupled to one or more output devices such as a display device 112, speaker, or the like. The processor 102 may communicate with one or more other computer systems by means of a network 114, such as a LAN, WAN, or the Internet. Communication over the network 114 may be facilitated by a network adapter 116.

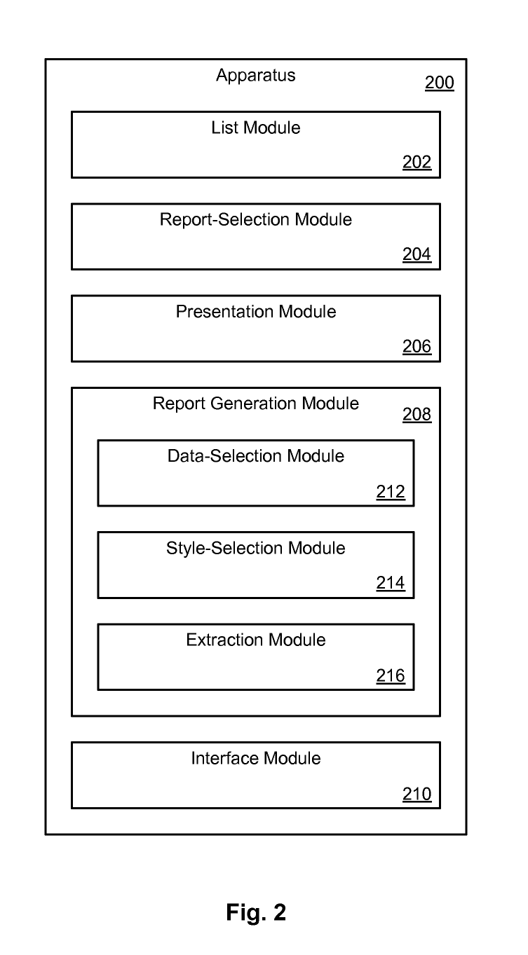

Referring to FIG. 2, one embodiment of an apparatus 200 for providing assisted business analysis to users is illustrated. As shown, the apparatus 200 includes one or more modules to provide various features and functions. These modules may be implemented in hardware, software or firmware executable on hardware, or a combination thereof. These modules are presented only by way of example and are not intended to be limiting. Indeed, alternative embodiments may include additional or fewer modules than those illustrated, or the modules may be organized differently. Furthermore, it should be recognized that, in some embodiments, the functionality of some modules may be broken into multiple modules or, conversely, the functionality of several modules may be combined into a single or fewer modules.

As shown in FIG. 2, in selected embodiments, the apparatus 200 includes one or more of a list module 202, a report-selection module 204, a presentation module 206, a report generation module 208, and an interface module 210. In selected embodiments, the report generation module 208 includes one or more of a data-selection module 212, a style-selection module 214, and an extraction module 216.

The list module 202 may present a list of predefined managed reports, created by a skilled business analyst, to a user. Each of these managed reports may have specific metadata associated therewith. This metadata may describe the type of data that is displayed in the managed report and describe the way the data is formatted. In general, to create a managed report, a skilled business analyst starts with a blank report, reviews the complete set of metadata items that are available, and selects metadata items that he or she wishes to include in the report. In typical business intelligence packages, there may be hundreds of different metadata items. These metadata items frequently have similar names and are often not compatible with one another. Choosing the right set of metadata to include in a managed report is often a daunting task that is only appropriate for a skilled business analyst.

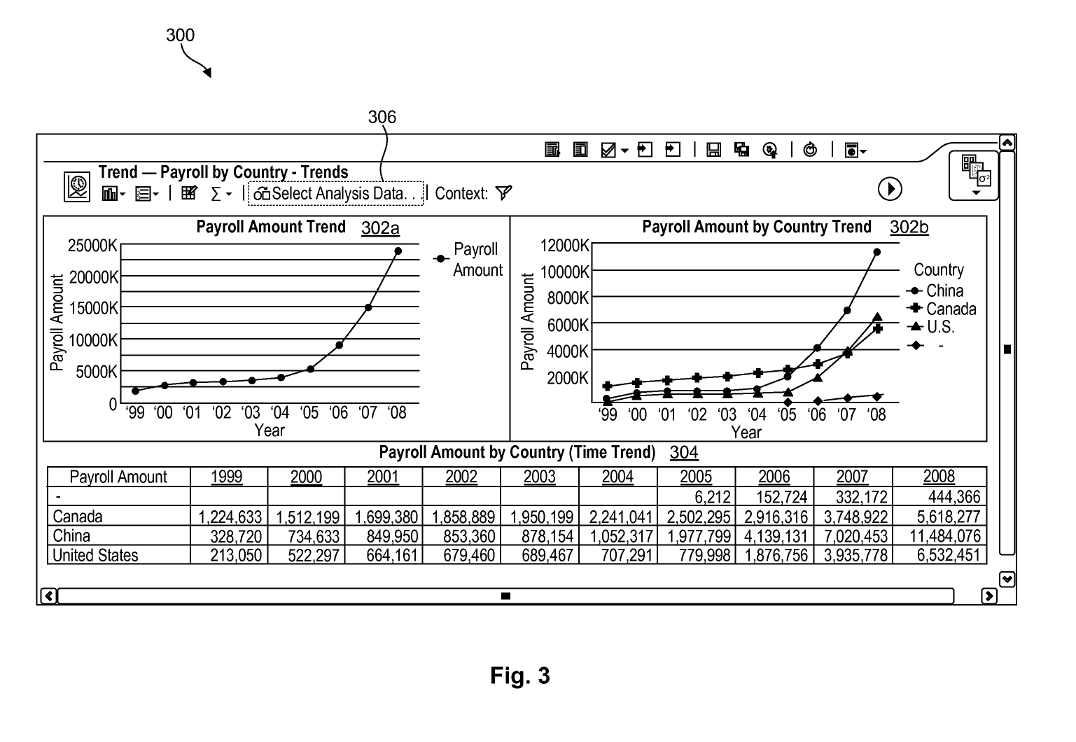

The report-selection module 204 enables the user to select a managed report from the list. Once selected, a presentation module 206 displays the managed report for viewing by the user. One non-limiting example of a managed report is illustrated in FIG. 3. Upon selecting a managed report, the report generation module 208 allows the user to generate a new ad hoc report from the selected managed report. To accomplish this, the report generation module 208 includes one or more of a data-selection module 212, a style-selection module 214, and an extraction module 216.

The data-selection module 212 enables a user to select types of data (by selecting one or more metadata categories, for example) that the user wants to extract from the selected managed report to include in the new ad hoc report. A style-selection module 214 allows the user to select an analytic style for the new ad hoc report. Different analytic styles may include, for example, trend analyses, period-on-period analyses, variance analyses, top contributors analyses, difference analyses, pareto analyses, reconciliations of balances with activity analyses, comparison analyses, summary analyses, and the like. An analytic style may describe the content (e.g., a trend analysis implies a calendar dimension), layout (e.g., a trend analysis may include one or more trend charts), and/or calculations (e.g., a period-on-period analysis implies calculating the difference between data from one period and another) of a report. The analytic style selected for the new ad hoc report may be completely different from the analytic style of the underlying managed report.

Once the desired metadata and analytic style are selected for the new ad hoc report, the report generation module 208 generates the new ad hoc report. Upon doing so, an extraction module 216 extracts all or part of the metadata (e.g., result objects, filters, calculations, etc.) from the underlying managed report for inclusion in the new ad hoc report. The report generation module 208 then applies rules associated with the analytic style to determine how this metadata is used to perform the type of analysis requested. In selected embodiments, rules applied by the report generation module 208 include one or more of: preserving measures and dimensions (e.g., if a predefined managed report shows sales by product, the report generation module 208 may attempt to accommodate both sales and product in the new ad hoc report); preserving calendar settings such as calendar type, calendar level, and/or time context (e.g., if a predefined managed report shows a summary for the year 2008, a new ad hoc trend report may show multiple years of data with 2008 being the last year shown); preserving other settings such as currency, join paths, and appropriate display of dimension member history.

The ability to extract metadata from an existing managed report and apply rules to the metadata for inclusion in a new ad hoc report substantially simplifies the report-generation process for the user. The user simply selects an existing managed report that contains content that closely or approximately matches what he or she is looking for, and then selects an analytic style to apply to the content. The report generation module 208 then automatically extracts the relevant metadata items from the selected managed report and applies rules to the metadata to perform the requested analysis. The user has no need to understand the various technical steps that would otherwise be necessary using conventional analytic processing technology, such as OLAP. In this way, the apparatus 200 allows users to perform sophisticated business analysis that would normally require help from skilled business analysts.

An interface module 210 may provide various user interfaces to enable the user to perform the above-described tasks, such as select and display a predefined managed report, select metadata and/or analytic styles to include in a new ad hoc report, initiate the generation and/or display of a new ad hoc report, or the like. In selected embodiments, the interface module 210 provides a web-based interface to enable a user to perform these tasks over a network, such as the Internet, using a web browser. Nevertheless, other user interfaces, such as non-web-based implementations, are also possible and within the scope of the invention.

Referring to FIG. 3, one example of the presentation of a managed report 300 is illustrated. It should be recognized that the presentation of the managed report 300, including the metadata and layout of the managed report 300, may take on many different forms. Thus, the illustrated managed report 300 is provided only by way of example and is not intended to be limiting. As shown, the predefined managed report 300 shows a trend analysis (i.e., the “analytic style” of the managed report 300 is that of a trend analysis). More specifically, the managed report 300 shows the overall payroll trend as well as the payroll trends by country for a business, in this example the payroll trends of Canada, China, and the United States. The managed report 300 uses a compound layout that includes a “Payroll Amount” trend chart 302a, a “Payroll Amount by Country” trend chart 302b, and a “Payroll Amount by Country” table 304. A presentation similar to that illustrated in FIG. 3 may be found in various managed reporting solutions. The analysis available in such managed reporting solutions is typically restricted to drilling down on predefined hierarchies (such as drilling down from years to months) or drilling through other predefined reports (such as drilling through a list of payroll transactions in Canada for 2008).

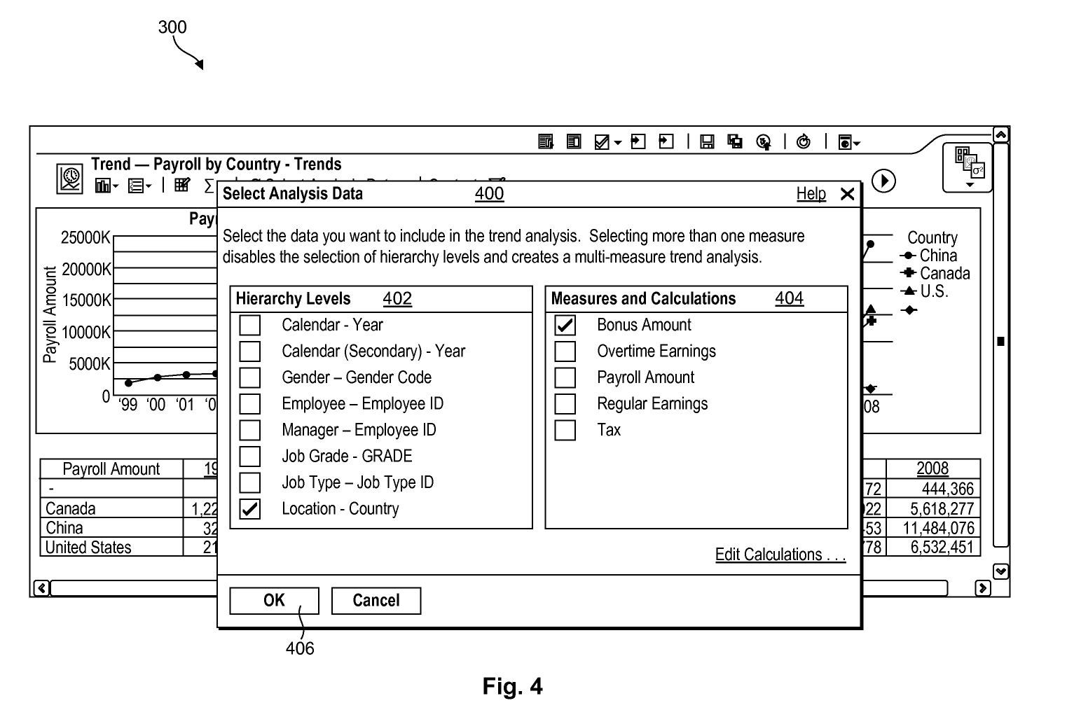

Referring to FIG. 4, one embodiment of a user interface 400 for making changes to a predefined managed report 300 is illustrated. Upon selecting a “Select Analysis Data” button 306 (see FIG. 3), a user interface 400 may appear to enable a user to make various changes to the managed report 300. For example, the user may choose from various hierarchy levels 402 (a hierarchy level may be considered a “dimension”) to change the dimensions of the managed report 300.

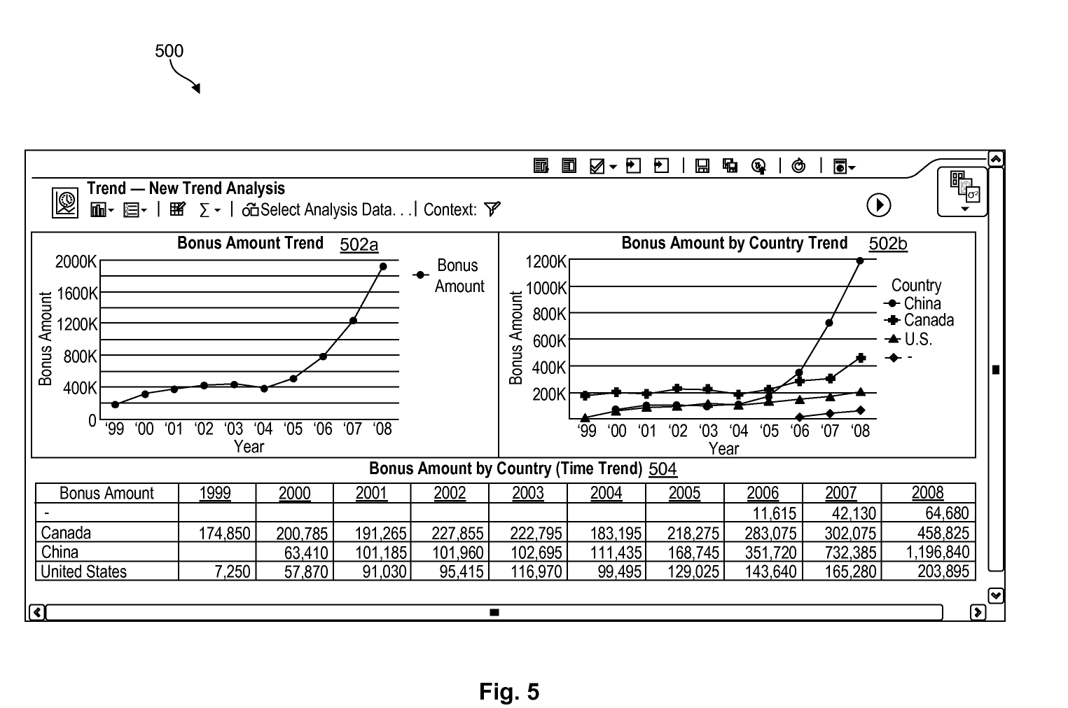

Similarly, the user may select from various measures 404 and calculations 404. The hierarchy levels 402 as well as the measures 404 and calculations 404 may both be considered types of metadata associated with the managed report 300. Modifying the managed report 300 may be as simple as selecting a new hierarchy level 402 or measure 404 on the user interface 400 to update the managed report 300 accordingly. In the illustrated example, the “Payroll Amount” measure 404 is changed to the “Bonus Amount” measure 404. Once the “OK” button 406 is selected to confirm the change, a modified version of the managed report 300 may be displayed. One example of such a modified managed report 500 is illustrated in FIG. 5.

As shown in FIG. 5, the modified managed report 500 now shows a trend analysis of the bonus amount as opposed to the payroll amount. More specifically, the managed report 500 shows the overall bonus amount trend as well as the bonus amount trend by country. The modified managed report 500 is arranged in a compound layout that includes a “Bonus Amount” trend chart 502a, a “Bonus Amount by Country” trend chart 502b, and a “Bonus Amount by Country” table 504. This format closely mirrors the format illustrated in FIG. 3. As can be observed in FIG. 5, in selected embodiments, changing the measure 404 “Payroll Amount” to “Bonus Amount” may cause global changes to be propagated through each of the charts 502a, 502b and table 504 illustrated in FIG. 5.

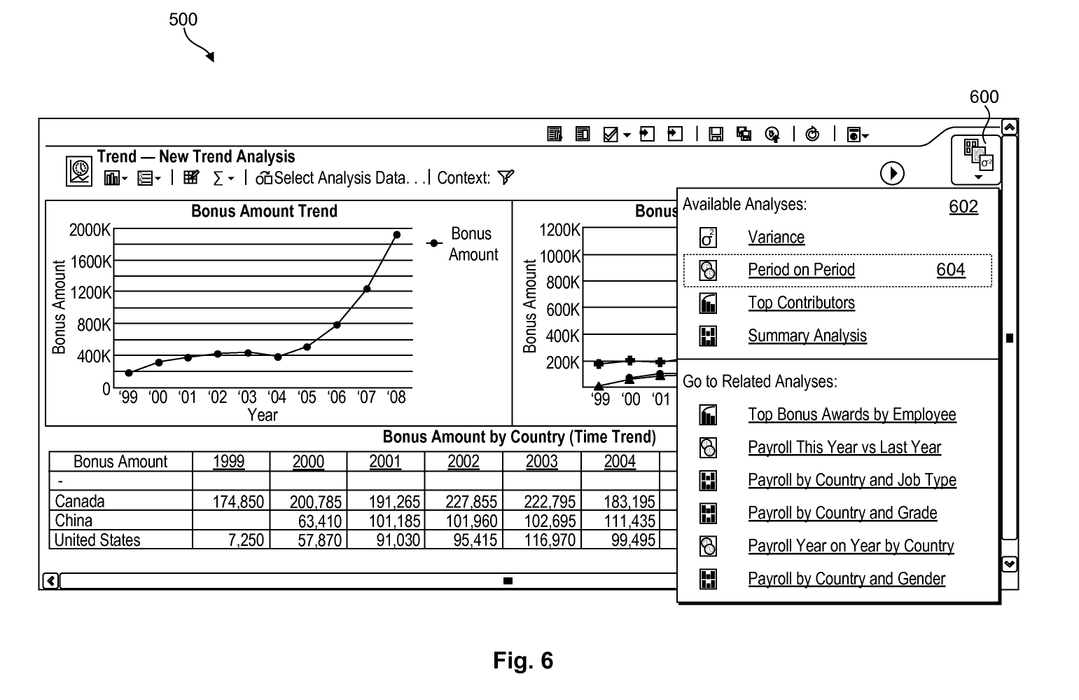

Referring to FIG. 6, as previously mentioned, the report generation module 208 enables a user to generate a new ad hoc report from a selected managed report. This substantially simplifies the report-generation process and facilitates analysis of business data by the user. In selected embodiments, a button 600 is provided to enable a user to select from various analytic styles and thereby initiate the generation of ad hoc reports. Upon selecting the button 600, a user interface 602, such as a menu 602, may appear to enable the user to choose from various analytic styles. In the illustrated example, the menu 602 allows a user to select from “variance,” “period-on-period,” “top contributors,” and “summary analysis” analytic styles, although other analytic styles may also be included. Selecting one of these analytic styles will invoke the report generation module 208 to generate a new ad hoc report based on the selected analytic style. In doing so, the report generation module 208 will extract metadata from the underlying managed report 500 to create the new ad hoc report.

For example, suppose that a user selects the “period-on-period” analytic style 604 from the menu 602. Selecting this analytic style will invoke the report generation module 208 such that it generates a new ad hoc report from the modified managed report 500 based on the period-on-period analytic style. When generating this report, the report generation module 208 extracts metadata from the underlying managed report 500 to create the new ad hoc report.

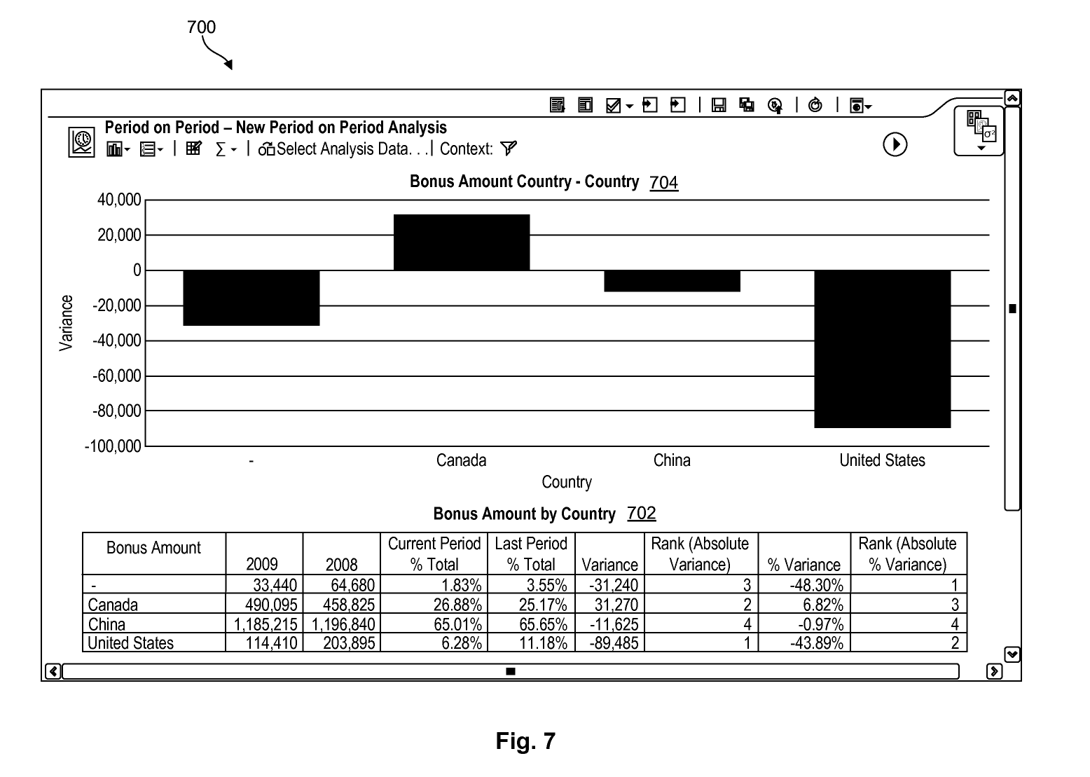

One example of an ad hoc report 700 created by selecting the period-on-period analytic style 604 is illustrated in FIG. 7. The format and layout of this ad hoc report 700 is presented only by way of example and is not intended to be limiting. As can be observed from FIG. 7, the report generation module 208 creates an ad hoc report 700 that includes a table 702 showing variance values and various calculations that highlight the difference between the years 2008 and 2009. The ad hoc report 700 further includes a chart 704 showing the variance of the bonus amount by country for the same period. As can be observed from FIG. 7, the new ad hoc report 700 uses a completely different format and template from the managed report 500 illustrated in FIG. 5, although much of the context (i.e., metadata such as countries, years, bonus amount, etc.) of the underlying managed report 500 is preserved.

In certain embodiments, changes to the metadata (and associated business data) of the underlying managed report 500 will automatically be propagated to the ad hoc report 700 (such as when the payroll analysis shown in FIG. 3 was modified to show the bonus amount in FIG. 5). In other embodiments, the ad hoc report 700 will remain the same regardless of whether changes are made to the underlying managed report 500. In selected embodiments, the user may be provided an option to choose whether changes should or should not be propagated to the ad hoc report 700 from the underlying managed report 500.

Once an ad hoc report 700 is generated, a user may choose to save the report 700. This report 700 may be saved such that it is accessible only to the user that created the report 700, or may be saved such that it is made accessible to other users. In certain embodiments, the metadata of ad hoc report 700, as well as the underlying managed report 500 may serve as the basis for creating yet other ad hoc reports.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in a block may occur out of the order noted in the Figures. For example, two blocks shown in succession may, in fact, be executed substantially concurrently, or the blocks may sometimes be executed in the reverse order, depending upon the functionality involved. Some blocks may be deleted or other blocks may be added depending on the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for providing assisted business analysis to a user, the method comprising:
providing a list of predefined managed reports to a user, each predefined managed report having specific metadata associated therewith;
providing functionality to enable the user to select a specific predefined managed report from the list; and
providing functionality to enable the user to generate a new ad hoc report from the selected predefined managed report, wherein generating a new ad hoc report comprises automatically extracting at least part of the metadata from the selected predefined managed report to build the new ad hoc report.

2. The method of claim 1, wherein the selected predefined managed report is displayed using a first analytic style.

3. The method of claim 2, wherein the new ad hoc report is displayed using a second analytic style substantially different from the first analytic style.

4. The method of claim 1, wherein enabling the user to generate a new ad hoc report further comprises enabling the user to select one of a plurality of analytic styles to generate the new ad hoc report.

5. The method of claim 4, wherein the plurality of analytic styles comprises at least one of the following analytic styles: a trend analysis, a period-on-period analysis, a variance analysis, a difference analysis, a pareto analysis, a summary analysis, and a top contributors analysis.

6. The method of claim 1, wherein automatically extracting at least part of the metadata comprises extracting at least one of the following types of metadata from the selected predefined managed report: measures, dimensions, and calendar settings.

7. The method of claim 1, wherein enabling the user to generate a new ad hoc report comprises enabling the user to generate the new ad hoc report through a web-based interface.
